(19) United States
(12) Patent Application Publication
(10) Pub. No.: US 2024/0161487 A1
(43) Pub. Date: May 16, 2024

(54) ADAPTIVE MIXED-RESOLUTION PROCESSING

(71) Applicant: QUALCOMM Incorporated, San Diego, CA (US)

(72) Inventors: Jakob DRACHMANN HAVTORN, Copenhagen (DK); Amelie Marie Estelle ROYER, Amsterdam (NL); Tijmen Pieter Frederik BLANKEVOORT, Amsterdam (NL); Babak EHTESHAMI BEJNORDI, Amsterdam (NL)

(21) Appl. No.: 18/478,714

(22) Filed: Sep. 29, 2023

Related U.S. Application Data
(60) Provisional application No. 63/424,761, filed on Nov. 11, 2022.

(51) Int. Cl. G06V 10/82; G06T 3/40

(52) U.S. Cl. CPC G06V 10/82; G06T 3/40

(57) ABSTRACT

Systems and techniques are described for adaptive mixed-resolution processing. According to some aspects, a device can divide an input image into first tokens having a first resolution and second tokens having a second resolution. The device can generate first token representations for token(s) from the first tokens corresponding to a first region of the input image and generate second token representations for token(s) from the second tokens corresponding to the first region of the input image. The device can process, using a neural network model, the first token representations and the second token representations to determine the first resolution or the second resolution as a scale for the first region of the input image. The device can process, using a transformer neural network model, the first region of the input image according to the scale for the first region.

### CROSS-REFERENCE TO RELATED APPLICATIONS

This application claims the benefit of U.S. Provisional Application No. 63/424,761, filed Nov. 11, 2022, which is hereby incorporated by reference, in its entirety and for all purposes.

### TECHNICAL FIELD

The present disclosure generally relates to processing image data using one or more machine learning systems. Aspects of the present disclosure are related to providing an adaptive mixed-resolution processing for generating input tokens at different resolutions for input to a machine learning system or model (e.g., transformer neural network system or model).

### BACKGROUND

Deep learning machine learning models (e.g., neural networks) can be used to perform a variety of tasks, such as detection and/or recognition (e.g., scene or object detection and/or recognition), depth estimation, pose estimation, image reconstruction, classification, three-dimensional (3D) modeling, dense regression tasks, data compression and/or decompression, image processing, among other tasks. Deep learning machine learning models can be versatile and can achieve high quality results in a variety of tasks. However, while deep learning machine learning models can be versatile and accurate, the models can be large and slow, and generally have high memory demands and computational costs. In many cases, the computational complexity of the models can be high and the models can be difficult to train.

In some cases, machine learning models may utilize one or more transformers. Tokens are used by the transformer as its base units for reasoning. For example, an input image can be divided into a number of tokens, which can be input to the transformer for processing. However, the tokenization process can be suboptimal, as the tokens carry no semantic meaning and the number of tokens increases quadratically with the image size, which can lead to inefficient machine learning models.

### SUMMARY

Systems and techniques are described for processing data (e.g., one or more images or video frames) by generating input tokens of the data at different resolutions for input to a machine learning system or model, such as a transformer.

In some aspects, a method of processing image data is provided. The method includes: dividing an input image into a first set of tokens having a first resolution and a second set of tokens having a second resolution; generating a first set of token representations for one or more tokens from the first set of tokens corresponding to a first region of the input image; generating a second set of token representations for one or more tokens from the second set of tokens corresponding to the first region of the input image; processing, using a neural network model, the first set of token representations and the second set of token representations to determine the first resolution or the second resolution as a scale for the first region of the input image; and processing, using a transformer neural network model, the first region of the input image according to the scale for the first region.

In some aspects, an apparatus for processing image data is provided. The apparatus includes at least one memory and at least one processor (e.g., configured in circuitry) coupled to the at least one memory and configured to: divide an input image into a first set of tokens having a first resolution and a second set of tokens having a second resolution; generate a first set of token representations for one or more tokens from the first set of tokens corresponding to a first region of the input image; generate a second set of token representations for one or more tokens from the second set of tokens corresponding to the first region of the input image; process, using a neural network model, the first set of token representations and the second set of token representations to determine the first resolution or the second resolution as a scale for the first region of the input image; and process, using a transformer neural network model, the first region of the input image according to the scale for the first region.

In some aspects, a non-transitory computer-readable medium is provided that includes stored thereon instructions that, when executed by one or more processors (e.g., configured in circuitry), cause the one or more processors to: divide an input image into a first set of tokens having a first resolution and a second set of tokens having a second resolution; generate a first set of token representations for one or more tokens from the first set of tokens corresponding to a first region of the input image; generate a second set of token representations for one or more tokens from the second set of tokens corresponding to the first region of the input image; process, using a neural network model, the first set of token representations and the second set of token representations to determine the first resolution or the second resolution as a scale for the first region of the input image; and process, using a transformer neural network model, the first region of the input image according to the scale for the first region.

In some aspects, an apparatus for processing image data is provided. The apparatus includes: means for dividing an input image into a first set of tokens having a first resolution and a second set of tokens having a second resolution; means for generating a first set of token representations for one or more tokens from the first set of tokens corresponding to a first region of the input image; means for generating a second set of token representations for one or more tokens from the second set of tokens corresponding to the first region of the input image; means for processing, using a neural network model, the first set of token representations and the second set of token representations to determine the first resolution or the second resolution as a scale for the first region of the input image; and means for processing, using a transformer neural network model, the first region of the input image according to the scale for the first region.

In some aspects, one or more of the apparatuses described herein is, is part of, and/or includes an extended reality (XR) device or system (e.g., a virtual reality (VR) device, an augmented reality (AR) device, or a mixed reality (MR) device), a mobile device (e.g., a mobile telephone or other mobile device), a wearable device, a wireless communication device, a camera, a personal computer, a laptop computer, a vehicle or a computing device or component of a vehicle, a server computer or server device (e.g., an edge or cloud-based server, a personal computer acting as a server device, a mobile device such as a mobile phone acting as a server device, an XR device acting as a server device, a vehicle acting as a server device, a network router, or other device acting as a server device), another device, or a combination thereof. In some aspects, the apparatus includes a camera or multiple cameras for capturing one or more images. In some aspects, the apparatus further includes a display for displaying one or more images, notifications, and/or other displayable data. In some aspects, the apparatuses described above can include one or more sensors (e.g., one or more inertial measurement units (IMUs), such as one or more gyroscopes, one or more gyrometers, one or more accelerometers, any combination thereof, and/or other sensor.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and aspects, will become more apparent upon referring to the following specification, claims, and accompanying drawings.

### BRIEF DESCRIPTION OF THE DRAWINGS

Illustrative examples of the present application are described in detail below with reference to the following figures:

FIG. 1 is a diagram illustrating an example of a convolutional neural network (CNN), according to aspects of the disclosure;

FIG. 2 is a diagram illustrating an example of a classification neural network system, according to aspects of the disclosure;

FIG. 3 is a diagram illustrating an example of existing tokenization processes, according to aspects of the disclosure;

FIG. 4 is a diagram illustrating an example of system that includes a pre-processing engine that generates mixed-scale data for a transformer, according to aspects of the disclosure;

FIG. 5 is a diagram illustrating a high-level overview of generating the mixed-scale tokens, according to aspects of the disclosure;

FIG. 6 is a diagram illustrating the difference between previous transformer processes and the mixed-scale approach disclosed herein, according to aspects of the disclosure;

FIG. 7 is a diagram illustrating an example of existing merging and pruning processes compared to the dynamic approach disclosed herein, according to aspects of the disclosure;

FIG. 8 is a diagram illustrating the comparison of fixed scale tokens and a dynamic mixed-scale pattern, according to aspects of the disclosure;

FIG. 9 is a diagram illustrating a binary gate decision process for each spatial position and each input image, according to aspects of the disclosure;

FIG. 10 is a diagram illustrating an example of a method for performing object detection, according to aspects of the disclosure;

FIG. 11 is a diagram illustrating an example of a computing system, according to aspects of the disclosure.

### DETAILED DESCRIPTION

Certain aspects of this disclosure are provided below. Some of these aspects may be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects only, and is not intended to limit the scope, applicability, or configuration of the disclosure. Rather, the ensuing description of the example aspects will provide those skilled in the art with an enabling description for implementing an example aspect. It should be understood that various changes may be made in the function and arrangement of elements without departing from the spirit and scope of the application as set forth in the appended claims.

As noted previously, some deep learning machine learning models (e.g., neural networks) may utilize one or more transformers. A transformer is a particular type of neural network. One example of a system that uses transformers is a MobileViT system described in MobileViT: Light-weight, General-purpose, and Mobile-friendly Vision Transformer, Mehta, Rastegari, ICLR, 2022, incorporated herein by reference. Transformers perform well when used for certain tasks (e.g., image classification and object detection), but require a large number of calculations to perform the image classification and object detection tasks.

Transformers typically use tokens as base units for processing or reasoning. For example, an input image can be divided into N tokens or patches (e.g., square tokens or patches) that are all of the same size. However, the tokenization process can be suboptimal, as the tokens carry no semantic meaning and the number of tokens increases quadratically with the image size, which can lead to an inefficient model. A transformer experiences a high cost in terms of multiply-addition calculations (MACs), which can be required as a function of the number of input tokens. For example, with an input size of 384 pixels, a patch size or scale value of 8 can result in 2048 tokens. In another example, a patch size or scale value of 32 can result in 100 tokens. In these two examples, there is a dramatic difference in the number of tokens used and the number of MACs required, particularly at the lower end of the number of tokens (e.g., 0-300 or other value). In many cases, current transformer-based models may utilize many more patches than are actually needed, such as because the patches do not carry any semantic information. Therefore, in general, is it desirable to structure the signal processing in a manner to reduce the number of patches and thus the number of tokens.

Furthermore, a transformer can include global attention blocks and independent token refinement blocks, which are impacted by the number of input tokens and at every layer. For example, in a global attention block of the transformer, every token of the input images provides an update to every other token during processing. The processing is performed in parallel. The update can be weighted by how similar two tokens are from one other. The cost for the global attention process can be quadratic in nature, such as O(N²) computations when there are N tokens. Furthermore, in an individual feed forward network (FFN) of the transformer, every token is updated independently and the parameters of the FFN are shared across all tokens. The processing of the FFN can also be performed in parallel. The cost of the FFN linearly scales with the FFN cost as O(N cost_{FFN}).

Systems, apparatuses (or devices), methods (also referred to as processes), and computer-readable media (collectively referred to herein as “systems and techniques”) are described herein for generating input tokens at different resolutions or scales for input to a machine learning system or model, such as a transformer-based neural network system or model. The systems and techniques can address the issue of a transformer having a large cost in terms of processing input images due to the number of tokens that are required for processing.

According to some aspects, the systems and techniques can predict a tokenization scale for each region of an image as a pre-processing step (e.g., performed by a pre-processing engine) before the transformer. Intuitively, uninformative image regions such as background can be processed at a coarser scale than the foreground, without loss of information, leading to a smaller total number of tokens.

To capture such behavior, a conditional gating engine (e.g., a neural network layer) can be trained to select the optimal tokenization scale for every coarse local region within the input image. In some cases, the gating engine can include a lightweight multi-layer perceptron (MLP) that takes a local coarse region of the image as input and predicts a tokenization scale for the region of the image, leading to a dynamic number of tokens per image. Because the gating engine operates at the input level, the gating engine is agnostic to the choice of transformer backbone network.

To avoid potential issues with learning such a scale selection engine (e.g., training with extra parameters for each scale or cumbersome training pipelines with multiple stages), a unified single-stage model can be trained by maximizing parameter sharing across scales. Further, to avoid the gating engine from falling in bad local minima (e.g., always outputting the same trivial static pattern), a training loss can be used that enables finer control over the learned gating distribution, enhancing the dynamic behavior of the mixed-scale tokenization. To reduce training costs, an adaptive trimming strategy at training time can be performed, which may rely on the underlying mapping between coarse and fine tokens.

The dynamic-scale (or mixed-scale) selection gating mechanism acts as a pre-processing stage, agnostic to the choice of transformer backbone, and can be trained jointly with the transformer in a single stage with mixed-scale tokens as inputs. Further, a generalization of batch-shaping can be used to better handle multi-dimensional distributions when training dynamic gates. The resulting loss provides better control over the learned scale distribution, and allows for easier and better initialization of the gates. The training overhead incurred from handling a set of tokens for each scale can also be reduced by defining the gate locally at the coarse token level only and employing an adaptive trimming strategy during training.

As previously noted, the systems and techniques introduce a mixed-scale (or mixed-resolution) transformer that can be configured as a unified model for handling input tokens from multiple scales (e.g., in parallel). As described above, a pre-processing engine can be applied to the input prior to the transformer to generate the tokens having the mixed resolutions or scales. For instance, the pre-processing engine can perform minimal token selection based on a gate decision by the gating engine and can mask input patches (e.g., of one or more images) following the gate decision. For example, based on a mask output by the gate decision, an input image can be divided into tokens of different resolutions. The tokens that are fed to the transformer can thus be configured with multiple different tokens having different scales.

In some cases, the pre-processing engine can be first or early on in terms of layers that process the input image. The pre-processing engine can dynamically generate mixed-scale tokens covering the entire image. The transformer can be modified if necessary to handle mixed-scale tokens. The transformer can then process the entire image with the mixed information from multiple image scales and in a more efficient manner as compared to existing techniques. In one illustrative example, an input image processed using existing techniques may result in 2000 tokens to be processed by the transformer, resulting in 2000² calculations. However, using the systems and techniques described herein, the number of tokens can be reduced to 250 or less, which results in the required calculations being reduced to 250² or less.

Mixing information from multiple image scales (e.g., by dividing an image into tokens of varying scales) can lead to computational efficiencies without a decline in performance, due at least in part to not all regions of an image including fine details. For example, some regions of an image (e.g., a blue sky) have little variance in texture (e.g., color, edges, etc.) and other regions (e.g., buildings, people, vehicles, etc.) can have detailed textures. In some cases, gate decision of the pre-processing engine can be based on learning a dynamic mixed-scale pattern early in the network (e.g., in one or more of the initial layers of the neural network model including the transformer), such as learning a background of a scene in an image versus one or more salient objects in the scene. In some cases, some images can have varying image complexity, in which one image might be a sunset with less complexity and another image might be a cluttered room with many different objects. For instance, the pre-processing engine can learn finer scales for salient objects (or for all foreground objects in some cases) or for more complex portions in an input image. The pre-processing engine can learn coarser scales for patches of the input image corresponding to background or for more simple portions of the input image. The pre-processing engine performs the gate decision noted above based on the importance or complexity of each region of the input image. The output of the gate decision (e.g., the mask) can indicate which image regions model will place a higher focus on by selecting a finer resolution. The systems and techniques can thus adapt to spend more time on complex regions of an image (or more complex images as a whole) and save more computations on simple portions of an image (or simple images as a whole) to optimize the average computational cost.

Learning the mixed-scale pattern early on based on the scene in the image can improve the efficiency of the system across all the layers. Leveraging the characteristic that different regions of the image include different levels of information, the systems and techniques enable a mixed image scale that is based on characteristics of each portion of the image.

The systems and techniques described herein can be used to enhance a machine learning system (e.g., a transformer-based model of a neural network) for performing any task of processing images or video frames videos. One benefit of the mixed-scale or resolution tokenization process is that it can improve the efficiency-accuracy tradeoff of vision transformers that are configured to process one or more images or video frames. For instance, the systems and techniques can be helpful with when processing sparse images with small objects, such as images used for aerial detection where the images are captured overhead and large distances.

Various aspects of the application will be described with respect to the figures.

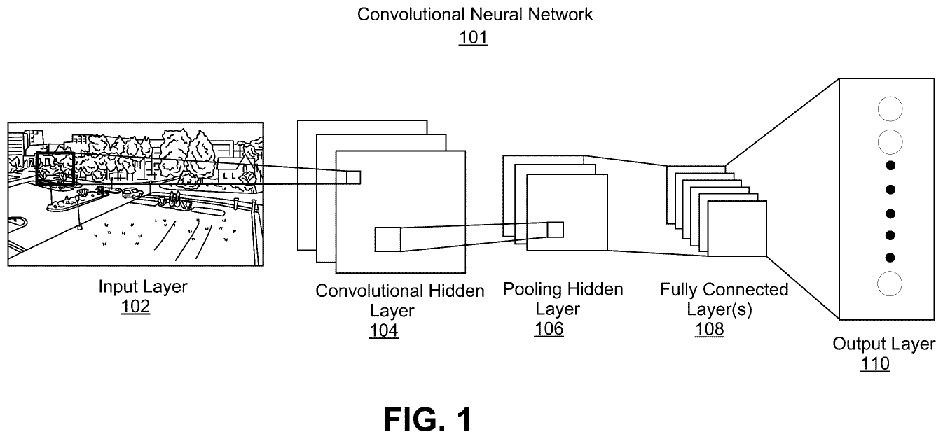

FIG. 1 is a diagram illustrating an example of a CNN 100. The input layer 102 of the CNN 100 includes data representing an image. For example, the data can include an array of numbers representing the pixels of the image, with each number in the array including a value from 0 to 255 describing the pixel intensity at that position in the array. Using the previous example from above, the array can include a 28×28×3 array of numbers with 28 rows and 28 columns of pixels and 3 color components (e.g., red, green, and blue, or luma and two chroma components, or the like). The image can be passed through a convolutional hidden layer 104, an optional non-linear activation layer, a pooling hidden layer 106, and fully connected hidden layers 108 to get an output at the output layer 110. While only one of each hidden layer is shown in FIG. 1, one of ordinary skill will appreciate that multiple convolutional hidden layers, non-linear layers, pooling hidden layers, and/or fully connected layers can be included in the CNN 100. As previously described, the output can indicate a single class of an object or can include a probability of classes that best describe the object in the image.

The first layer of the CNN 100 is the convolutional hidden layer 104. The convolutional hidden layer 104 analyzes the image data of the input layer 102. Each node of the convolutional hidden layer 104 is connected to a region of nodes (pixels) of the input image called a receptive field. The convolutional hidden layer 104 can be considered as one or more filters (each filter corresponding to a different activation or feature map), with each convolutional iteration of a filter being a node or neuron of the convolutional hidden layer 104. For example, the region of the input image that a filter covers at each convolutional iteration would be the receptive field for the filter. In one illustrative example, if the input image includes a 28×28 array, and each filter (and corresponding receptive field) is a 5×5 array, then there will be 24×24 nodes in the convolutional hidden layer 104. Each connection between a node and a receptive field for that node learns a weight and, in some cases, an overall bias such that each node learns to analyze its particular local receptive field in the input image. Each node of the hidden layer 104 will have the same weights and bias (called a shared weight and a shared bias). For example, the filter has an array of weights (numbers) and the same depth as the input. A filter will have a depth of 3 for the video frame example (according to three color components of the input image). An illustrative example size of the filter array is 5×5×3, corresponding to a size of the receptive field of a node.

The convolutional nature of the convolutional hidden layer 104 is due to each node of the convolutional layer being applied to its corresponding receptive field. For example, a filter of the convolutional hidden layer 104 can begin in the top-left corner of the input image array and can convolve around the input image. As noted above, each convolutional iteration of the filter can be considered a node or neuron of the convolutional hidden layer 104. At each convolutional iteration, the values of the filter are multiplied with a corresponding number of the original pixel values of the image (e.g., the 5×5 filter array is multiplied by a 5×5 array of input pixel values at the top-left corner of the input image array). The multiplications from each convolutional iteration can be summed together to obtain a total sum for that iteration or node. The process is next continued at a next location in the input image according to the receptive field of a next node in the convolutional hidden layer 104.

For example, a filter can be moved by a step amount to the next receptive field. The step amount can be set to 1 or other suitable amount. For example, if the step amount is set to 1, the filter will be moved to the right by 1 pixel at each convolutional iteration. Processing the filter at each unique location of the input volume produces a number representing the filter results for that location, resulting in a total sum value being determined for each node of the convolutional hidden layer 104.

The mapping from the input layer to the convolutional hidden layer 104 is referred to as an activation map (or feature map). The activation map includes a value for each node representing the filter results at each locations of the input volume. The activation map can include an array that includes the various total sum values resulting from each iteration of the filter on the input volume. For example, the activation map will include a 24×24 array if a 5×5 filter is applied to each pixel (a step amount of 1) of a 28×28 input image. The convolutional hidden layer 104 can include several activation maps in order to identify multiple features in an image. The example shown in FIG. 1 includes three activation maps. Using three activation maps, the convolutional hidden layer 104 can detect three different kinds of features, with each feature being detectable across the entire image.

In some examples, a non-linear hidden layer can be applied after the convolutional hidden layer 104. The non-linear layer can be used to introduce non-linearity to a system that has been computing linear operations. One illustrative example of a non-linear layer is a rectified linear unit (ReLU) layer. A ReLU layer can apply the function f(x)=max(0, x) to all of the values in the input volume, which changes all the negative activations to 0. The ReLU can thus increase the non-linear properties of the CNN 100 without affecting the receptive fields of the convolutional hidden layer 104.

The pooling hidden layer 106 can be applied after the convolutional hidden layer 104 (and after the non-linear hidden layer when used). The pooling hidden layer 106 is used to simplify the information in the output from the convolutional hidden layer 104. For example, the pooling hidden layer 106 can take each activation map output from the convolutional hidden layer 104 and generates a condensed activation map (or feature map) using a pooling function. Max-pooling is one example of a function performed by a pooling hidden layer. Other forms of pooling functions be used by the pooling hidden layer 104, such as average pooling, L2-norm pooling, or other suitable pooling functions. A pooling function (e.g., a max-pooling filter, an L2-norm filter, or other suitable pooling filter) is applied to each activation map included in the convolutional hidden layer 104. In the example shown in FIG. 1, three pooling filters are used for the three activation maps in the convolutional hidden layer 104.

In some examples, max-pooling can be used by applying a max-pooling filter (e.g., having a size of 2×2) with a step amount (e.g., equal to a dimension of the filter, such as a step amount of 2) to an activation map output from the convolutional hidden layer 104. The output from a max-pooling filter includes the maximum number in every sub-region that the filter convolves around. Using a 2×2 filter as an example, each unit in the pooling layer can summarize a region of 2×2 nodes in the previous layer (with each node being a value in the activation map). For example, four values (nodes) in an activation map will be analyzed by a 2×2 max-pooling filter at each iteration of the filter, with the maximum value from the four values being output as the “max” value. If such a max-pooling filter is applied to an activation filter from the convolutional hidden layer 104 having a dimension of 24×24 nodes, the output from the pooling hidden layer 106 will be an array of 12×12 nodes.

In some examples, an L2-norm pooling filter could also be used. The L2-norm pooling filter includes computing the square root of the sum of the squares of the values in the 2×2 region (or other suitable region) of an activation map (instead of computing the maximum values as is done in max-pooling), and using the computed values as an output.

Intuitively, the pooling function (e.g., max-pooling, L2-norm pooling, or other pooling function) determines whether a given feature is found anywhere in a region of the image, and discards the exact positional information. This can be done without affecting results of the feature detection because, once a feature has been found, the exact location of the feature is not as important as its approximate location relative to other features. Max-pooling (as well as other pooling methods) offer the benefit that there are many fewer pooled features, thus reducing the number of parameters needed in later layers of the CNN 100.

The final layer of connections in the network is a fully-connected layer that connects every node from the pooling hidden layer 106 to every one of the output nodes in the output layer 110. Using the example above, the input layer includes 28×28 nodes encoding the pixel intensities of the input image, the convolutional hidden layer 104 includes 3×24×24 hidden feature nodes based on application of a 5×5 local receptive field (for the filters) to three activation maps, and the pooling layer 106 includes a layer of 3×12×12 hidden feature nodes based on application of max-pooling filter to 2×2 regions across each of the three feature maps. Extending this example, the output layer 110 can include ten output nodes. In such an example, every node of the 3×12×12 pooling hidden layer 106 is connected to every node of the output layer 110.

The fully connected layer 108 can obtain the output of the previous pooling layer 106 (which should represent the activation maps of high-level features) and determines the features that most correlate to a particular class. For example, the fully connected layer 108 layer can determine the high-level features that most strongly correlate to a particular class, and can include weights (nodes) for the high-level features. A product can be computed between the weights of the fully connected layer 108 and the pooling hidden layer 106 to obtain probabilities for the different classes. For example, if the CNN 100 is being used to predict that an object in a video frame is a person, high values will be present in the activation maps that represent high-level features of people (e.g., two legs are present, a face is present at the top of the object, two eyes are present at the top left and top right of the face, a nose is present in the middle of the face, a mouth is present at the bottom of the face, and/or other features common for a person).

In some examples, the output from the output layer 110 can include an M-dimensional vector (in the prior example, M=10), where M can include the number of classes that the program has to choose from when classifying the object in the image. Other example outputs can also be provided. Each number in the N-dimensional vector can represent the probability the object is of a certain class. In one illustrative example, if a 10-dimensional output vector represents ten different classes of objects is [0 0 0.05 0.8 0 0.15 0 0 0 0], the vector indicates that there is a 5% probability that the image is the third class of object (e.g., a dog), an 80% probability that the image is the fourth class of object (e.g., a human), and a 15% probability that the image is the sixth class of object (e.g., a kangaroo). The probability for a class can be considered a confidence level that the object is part of that class.

One issue with backbones that use convolutional layers to extract high-level features, such as the CNN 100 in FIG. 1, is that the receptive field is limited by convolution kernel size. For instance, convolutions cannot extract global information. As noted above, transformers can be used to extract global information, but are computationally expensive and thus add significant latency in performing object classification and/or detection tasks.

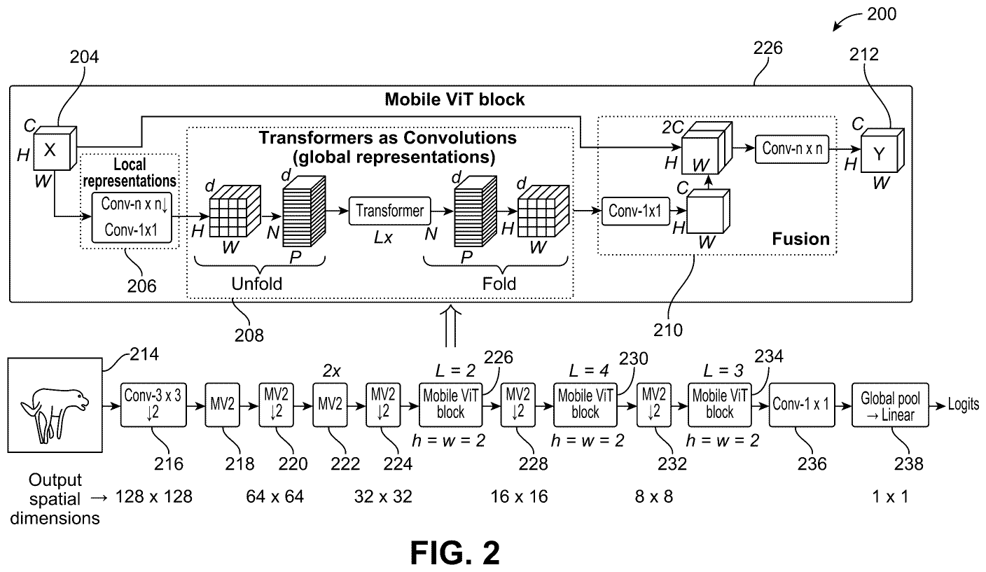

FIG. 2 illustrates a classification neural network system 200 including a mobile vision transformer (MobileViT) block 226. The MobileViT block 226 builds upon the initial application of transformers in language processing and applies that technology to images. Transformers for image processing measure the relationship between pairs of input tokens or pixels as the basic unit of analysis. However, computing relationships for every pixel pair in a typical image is prohibitive in terms of memory and computation. MobileViT 2-2 computes relationships among pixels in various small sections of the image (e.g., 16×16 pixels), at a drastically reduced cost. The sections (with positional embeddings) are placed in a sequence. The embeddings are learnable vectors. Each section is arranged into a linear sequence and multiplied by the embedding matrix. The result, with the position embedding is fed to the transformer 208.

An input image 214 having a height H, a width W, and a number of channels (e.g., H*W pixels with 3 channels corresponding to red, green, and blue color components) is provided to a convolution block 216. The convolution block 216 applies a 3×3 convolutional kernel (with a step amount or stride of 2) to the input image 214. The output of the convolution block 216 is passed through a number of MobileNetv2 (MV2) blocks 218, 220, 222, 224 to generate a down-sampled output set of features 204 having a height H, a width W, and a dimension C. Each MobileNetv2 218, 220, 222, 224 is a feature extractor for extracting features from an output of a previous layer. Other feature extractors other than MobileNetv2 blocks can be used in some cases. Blocks that perform down-sampling are marked with a ↓2 (corresponding to a step amount or stride of 2).

As shown in FIG. 2, the MobileViT bock 226 is illustrated in more detail than other MobileViT bocks 230 and 234 of the classification neural network system 200. As shown, the MobileViT block 226 can process the features 204 using convolution layers to generate local representations 206. The transformers as convolutions can produce a global presentation by unfolding the data or a set of features (having a dimension of H, W, d), performing transformations using the transformer, and folding the data back up again to yield another set of features (having a dimension of H, W, d) that is then output to the fusion layer 210. The MobileViT block replaces the local processing of convolutional operations with global processing the using transformer.

The fusion layer 210 can fuse the data or compare it to the original data 204 to generate the output features Y 212. The features Y 212 output from the MobileViT block 226 can be processed by the MobileNetv2 block 228, followed by another application of the MobileViT block 230, followed by another application of MobileNetv2 block 232 and another application of the MobileViT block 234. A 1×1 convolutional layer 236 (e.g., a fully connected layer) can then be applied to generate a global pool 238 of outputs. It is noted that the downsampling of the data across the various block operations results in taking an image size of 128×128 at block 216 and generating a 1×1 output at block 238, which includes a global pool of linear data.

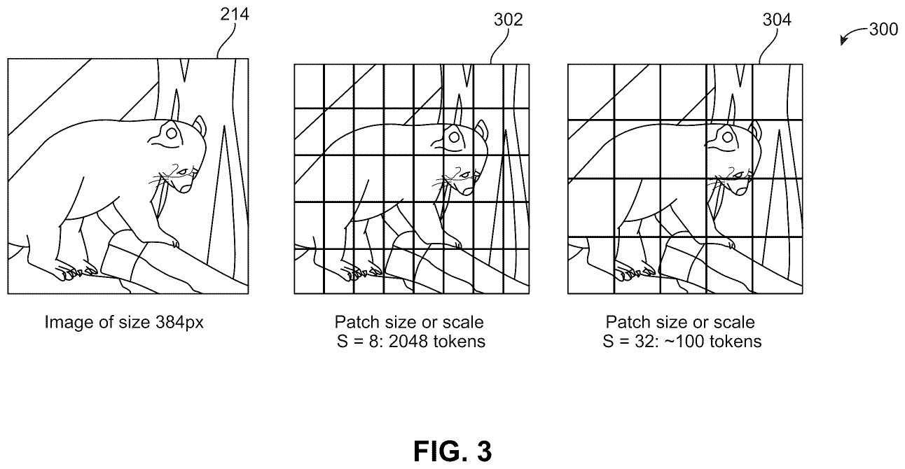

FIG. 3 is a diagram 300 illustrating an example of existing tokenization processes. An input image 214 in one example can have an image size of 384 pixels. The image 214 can be divided into patches or tokens at different scales. In one example, the patch size 302 is eight which results in 2048 tokens being generated to cover the entire image. The patch size can refer to the number of pixels in a respective patch. In one aspect, that patch size can refer to one side of the square patch (e.g., patch size=16 for a patch having a resolution of 16×16 pixels). The representation 304 is not to scale. In another representation 304, the patch size or scale could be 32, which can result in 100 tokens being generated. Typically, the transformer or component will split the image 214 into the same sized squared patches or tokens which are then used as base units for reasoning or determining what objects are in the image 214. The transformer performs multiply-addition calculations (MACs) as a function of the number of input tokens and thus the more input tokens the higher the cost. As noted previously, the number of tokens can increase quadratically with image size which leads to inefficient models.

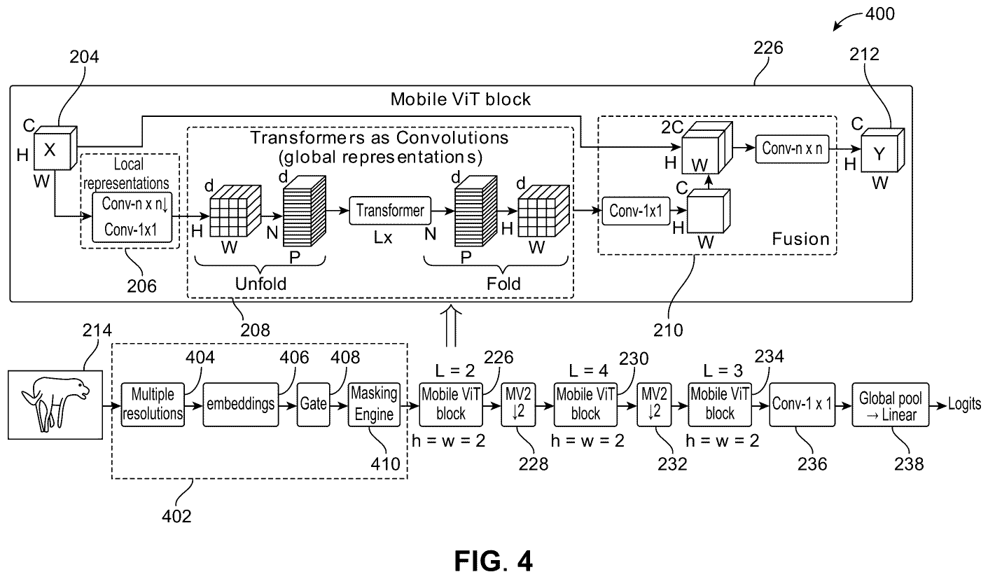

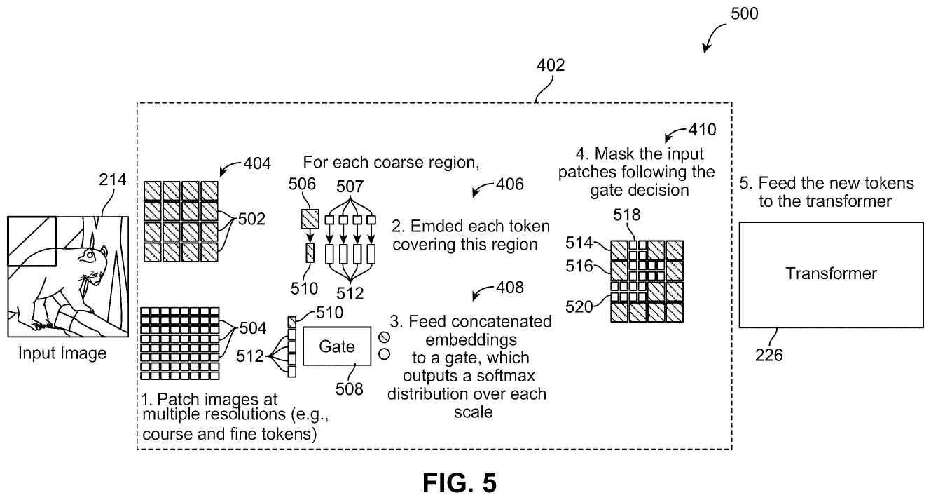

FIG. 4 is a diagram illustrating an example of system 400 that includes a pre-processing engine 402 that generates mixed-scale (or mixed-resolution) tokens for a transformer 226, according to the systems and techniques described herein. In some cases, one or more components illustrated in FIG. 4 are similar to those shown in FIG. 2. For example, the pre-processing engine 402 of FIG. 4 can replace or can occur in series at any location with the components 216, 218, 220, 222, 224 shown in FIG. 2. FIG. 5 will be referenced as well in the discussion of FIG. 4.

FIG. 5 is a diagram illustrating an example of a high-level overview 500 of generating the mixed-scale tokens. In general, it can be beneficial to position the pre-processing engine 402 early on in the processing of the input image 214. Positioning the pre-processing engine 402 “early on” can mean that the first layer of the network is the pre-processing engine 402 or that the pre-processing engine 402 may be used as one of the first set of input layers of the network. In some cases, the pre-processing engine 402 can include a combination of neural network layers, such as convolutional layers, linear layers, non-linear layers, max-pooling layers, and softmax layers. The types and number of layers can vary within the pre-processing engine 402. The overall processing is described but can be achieved by a variety of different layering structures.

The pre-processing engine 402 can include a first engine 404 that divides the input image 214 into at least two sets of patches or tokens at multiple resolutions. For example, the first engine 404 can divide the input image 214 into a first set of tokens at a first resolution, which can be for example a coarse resolution with larger patches or tokens as shown in patches 502 in FIG. 5. The first engine 404 can divide the input image 214 into a second set of tokens at a second resolution, which can be for example a fine resolution with smaller patches or tokens as shown in patches 504 in FIG. 5. In one illustrative example, the input image 214 can be patched into coarse image regions of size S_{c}×S_{c}. While two different resolutions are shown, additional sets of patches could be created as well at even finer or coarser resolutions. Note that the definition of fine or coarse can be relative to each other or other resolutions.

Each coarse region can be processed by a gate 408 (e.g., shown in FIG. 5 as gate 508), which can be denoted as gate g. In some cases, the gates 408, 508 can include a 4-layer multi-layer perceptron (MLP). The gate 408, 508 can output a binary decision (e.g., in the form of a mask m, which in some cases can be generated by a masking engine 410) of whether the region is to be further processed at a coarse or fine scale. The resulting mask, m, defines the set of mixed-scale tokens for the input image. The corresponding mixed-scale position encodings can be obtained by linearly interpolating the fine scale position encodings to the coarse scale, when needed. The tokens can then be sent to transformer 226, which can be a standard transformer backbone T. The transformer 226 can output a task-relevant prediction.

An embedding engine 406 can perform the operation of embedding each token covering a particular region of the input image 214. For example, the embedding engine 406 can process the tokens in each region of the input image 214 (e.g., using one or more convolutional layers, activation layers, pooling layers, etc.) to generate a feature vector for each token. The coarse tokens can be grouped with the finer-scale tokens that correspond to a common region of the input image 214. For example, as shown in FIG. 5, a first coarse token 506 corresponding to a region of the input image 214 is grouped with four fine tokens 507 that also correspond to the same region of the input image 214. For instance, the portion of the input image 214 that the coarse token 506 covers is co-located with the portion in the input image 214 the four fine tokens 507 cover. In some cases, the different resolution tokens may not perfectly be co-located. For example, the four fine tokens 507 may cover a slightly larger region of the input image 214 (referred to as “spillover”) as compared to a region of the input image 214 that is covered by the coarse token 506. The existence of spillover or not may be based on a number of different factors, such as a characteristic of the portion of the image (smooth and consistent or complex), a desired accuracy level, a desired computational amount, and/or other factors.

In one illustrative example, as shown in FIG. 5, a factor of four can be used to transition from a coarse resolution (one token for a portion of the image) to a fine resolution (e.g., four tokens for the same portion of the image or at least a partially overlapping portion of the image). Other factors can be used as well. Furthermore, while the example shape of the token is square, other shapes are contemplated as well. In one example, a shape for a resolution (or different shapes for a resolution) can be chosen based on a similar model such as a gate 408 (shown in FIG. 5 as gate 508), which can also be referred to as a gating engine, which can be trained on how to output token shapes based on characteristics of the data.

The embedded tokens 510, 512 can be combined (e.g., concatenated) and input as an input vector (or other representation) to the gate 408. The gate 408 can perform a binary operation to determine whether to use the fine scale or the coarse scale for a particular region or portion of the input image 214. In one example, the gate 408 can process the portion of the image related to a coarse resolution and determine whether the portion of the image is simple, complex, or has some other characteristic that leads to one or the other binary output decision to represent the portion with a coarse resolution or fine resolution. For example, if the portion of the input image 214 covered by the concatenated tokens is consistent across the portion (e.g., includes pixels associated with a blue sky), then the coarse token can be assigned to represent that portion of the image. In another aspect, if the region is detailed and has different colors or shapes (e.g., includes pixels corresponding to a person or people), then the gate 408 can determine that the region should be represented by the set of fine tokens 512.

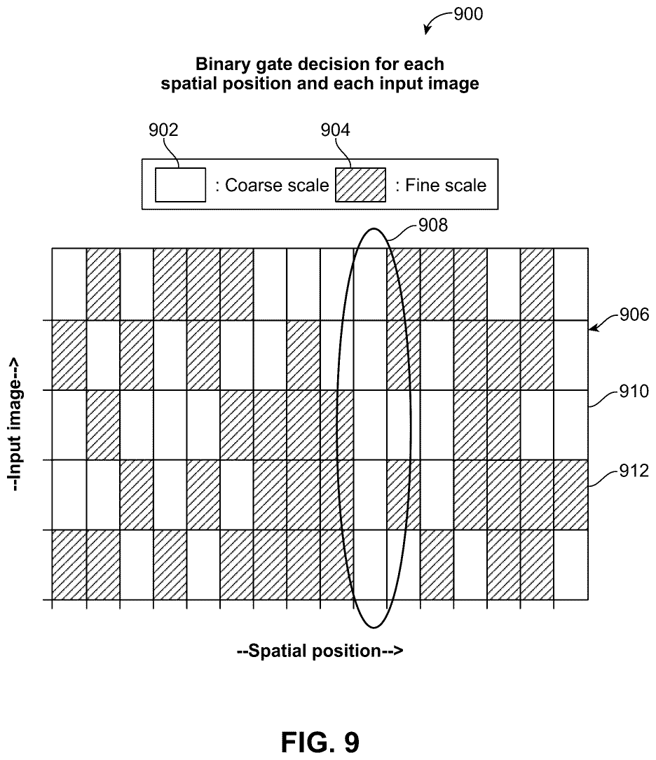

In some cases, the gate 408 can include a softmax layer, which can output a softmax distribution over each scale (e.g., the coarse scale and the fine scale). In one aspect, the gate 408 can include multiple layers of the network, such as one or more linear layers followed by a softmax layer that evaluates the input vector (including the embedded coarse token 510 and the embedded fine tokens 512) to determine which token or set of tokens at which resolution should represent the particular portion or region of the input image 214. A more flexible training constraint can apply to the gate 408 that enhances more diverse dynamic patterns, as described in more detail below with respect to FIG. 9. The gate 408 may represent multiple trained gates in some cases, with each respective gate operating on a spatial position within an input image. In some cases, the gate 408 could also be trained to select from more than two resolution options. There could be an embedding for the entire image provided via an input vector to the gate 408 such that information about how the specific portion being processed relates to the entire image could be used to determine the resolution selection.

In some aspects, the gate 408 can receive other information as input. For instance, the additional information can be combined with the embedding vectors of the tokens (e.g., concatenated) to generate the input vector that is provided to the gate 408. For example, a two-dimensional position of a token in the input image 214 (or a position of a portion of in the input image 214 that includes the token) can also be provided in the input vector to the gate 408, such that the portion can be evaluated in the positional context of the larger image. In one illustrative example, when the portion of the input image being processed is in the middle, or in a corner or an edge, then that respective position can impact the output resolution decision. In some cases, it may be more efficient to use a finer resolution for a portion in the middle of the image 214 and a coarse resolution for an edge or corner of the image 314. The gate 408 can be trained using one or more of the various types of input data for use in its evaluation.

In some cases, various designs can be used for the gate 408. In one aspect, the gate 408 can receive as an input concatenated embeddings of tokens in a region at all scales, which can be useful for lossless token reduction. In such an aspect, the pre-processing engine 402 can embed each token covering a region and can feed the concatenated embeddings to the gate 408, which can output a softmax distribution over each scale. As a result, each pixel in the image is represented in one token at the gate-selected scale and thus there is no loss of information. In another aspect, the gate 408 may take as input individual tokens, where the input to the gate 408 can be individual tokens provided serially rather than as a concatenated set of tokens. Such a solution may not be lossless, but can allow the generation of a unified model that encompasses both token pruning and dynamic scale selection. Such a solution can be useful in global tasks such as image classification. In such cases, rather than receiving concatenated embeddings (with a coarse scale token plus fine scale associated tokens), the gate 408 can receive a coarse scale token and determine whether to drop that token or to keep that token as a binary decision. The gate 408 can then receive a fine scale token and determine whether to drop or the keep that token as the binary decision.

In some aspects, the transformer 226 model is fully shared across the various scales. In some examples, the system can use random cropping data augmentations which can help the initial token linear embedding to be robust to scale changes. In some cases, positional encodings indicating a two-dimensional spatial position information for each token can be added as input to the transformer 226. In some cases, to share the positional encodings across the scales, the system can linearly interpolate the two-dimensional positions to match each given scale, allowing the position encodings parameters are effectively shared. For example, the system can linearly interpolate the positional encodings of four fine-scale tokens to generate a coarse scale positional encoding for the corresponding encompassing coarse scale token.

The output of the gate 408 is then provided to a masking engine 410 that masks the input patches or tokens according to the data received from the gate 408. The masking as shown in FIG. 5 provides, for each region of the input image 214, a coarse token 514, 516 covering a respective region or a fine set of tokens 518, 520 covering the respective region. In the example of FIG. 5, the masked set of tokens can cover all of the portions of the input image 214 using either a set of fine tokens or a coarse token. The masked set of tokens is provided to the transformer 226 which can further process the image.

The network 500 in general can be defined as two different blocks, including the pre-processing engine 402 as a first block and the transformer 226 as a second block. In some cases, an input layer can be considered as a unified model embodied as the pre-processing engine 402 and prior to the transformer 226. The pre-processing engine 402 enables the transformer 226 as a second layer that can handle input tokens from multiple scales at once. The masking engine 410 feeds the masked tokens to the transformer 226. Using such a structure, traditional transformer architectures (without any change(s)) can be used for the transformer 226.

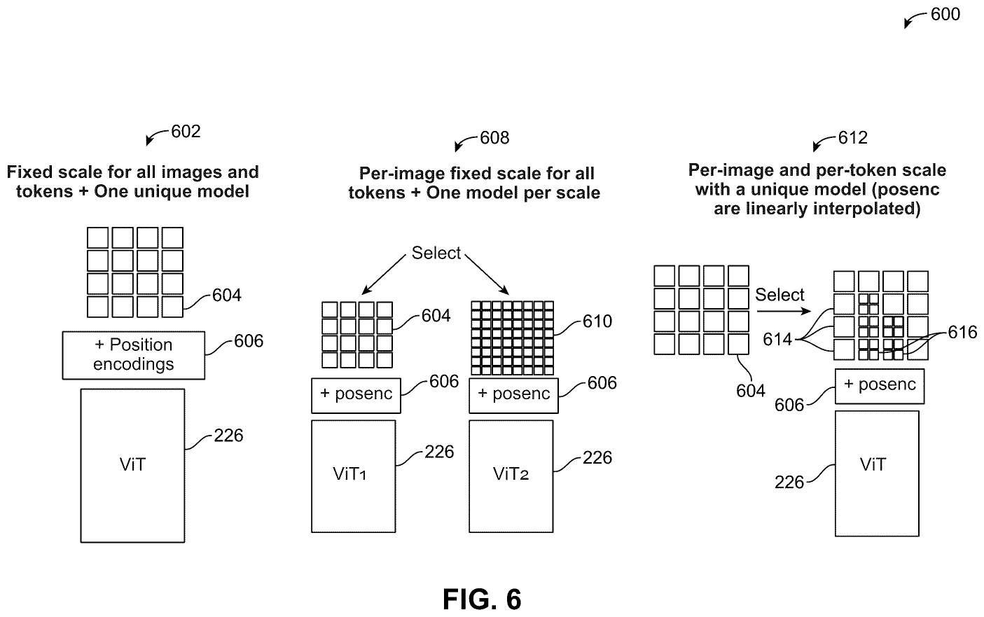

FIG. 6 is a diagram 600 illustrating the difference between previous transformer processes 602, 608 and the mixed-scale approach 612 disclosed herein. In a standard vision transformer approach 602, there is a fixed scale for all images and tokens 604. The embedding of the patches involves providing the position encoding to each patch or token and the result is provided to the vision transformer 226. In a revised vision transformer approach 608, a per-image fixed scale is used for all the tokens plus one model per scale. Thus, the system may select a first set of tokens 604 at a first resolution and embed 606 the positional encodings for the tokens 604 and the use a first vision transformer 226 to process the tokens 604. Another set of tokens 610 at a different resolution can be embedded 606 with positional encodings and provided to a second vision transformer 226 to process the set of tokens 610 at the second resolution.

In contrast, the approach 612 disclosed herein performs a per image and per-token scaling with a unique model in which, from the initial set of tokens 604 at the first resolution, another set of tokens in co-located positions and at a different scale can be used to generate a masked set of tokens in which some tokens 614 are at a first resolution and another set of tokens 616 are at a second (and perhaps more fine) resolution. This unified mixed-scale model can have a benefit of being parameter-efficient in terms of memory savings and data-efficient in terms of easier training. The embedding process 606 in this case includes a linear interpolation of two-dimensional positions that are part of the positional encodings (which are not provided in the prior approaches), such that the positional encodings are shared across different scales. The approach enables a unified mixed-scale model 226 as the vision transformer to be able to be more parameter efficient and data-efficient to handle mixed-scale input 612.

In one case, the pre-processing engine 402 can select a scale, learn positional encoding for one scale (e.g., a fine scale) then to get the other scale (e.g., a coarse scale) by linearly interpolated from one scale to the other. Then the result can be fed to the transformer 226. The transformer 226 knows each scale for each token. The transformer 226 also will know about the two-dimensional position and the scale for each token. The transformer 226 can know how to adapt to the different resolutions of the tokens.

The linear interpolation can operate as follows. If the two-dimensional position of the fine scale tokens is known, such as tokens 616, but the chosen resolution for that portion of the image is a coarse resolution, and thus in that position there is a coarse resolution token rather than four fine resolution tokens, then the system can take an average of their position or a linear interpolation of the two-dimensional position of the four fine resolution tokens and that can represent the position of the coarse token at that location. This can occur where the system has learned a vector for each position of the fine resolution tokens. There is a vector for each of those cells. To get to the coarse token location, the system can average the four respective vectors that have been learned for the four associated fine resolution tokens. The new identifier for the coarse token inherently has some information associated with a coarse resolution. It can give more information in an integrated way.

In one example, only the fine scale resolution tokens are embedded with positional vectors and the system will always use the fine scale resolution token positional vectors to interpolate the position for a coarse scale token when the gate 408 selects the coarse resolution for a portion of the image.

This approach works well for the example structure where the four fine resolution tokens 616 could be co-located over a coarse resolution token. If the different resolution tokens are not co-located or if the relationship between different resolutions is more complicated than the example framework, then other approaches can be implemented to obtain a proper position for a coarse level token based on two or more fine resolution tokens that have some association with the coarse resolution token, such as at least a partial overlap of a portion of the input image.

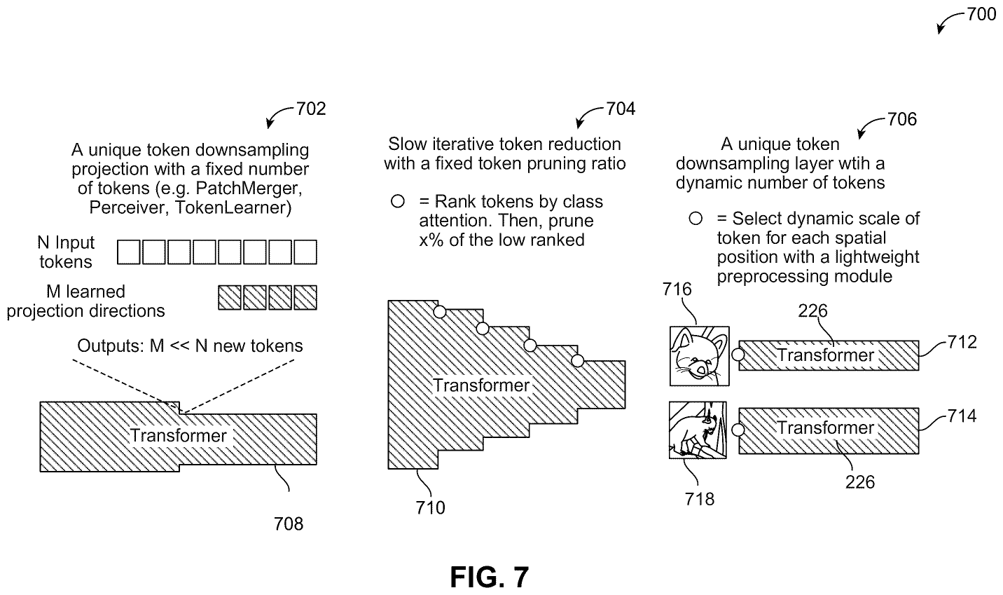

FIG. 7 is a diagram 700 illustrating an example of existing merging 702 and pruning 704 processes compared to the dynamic approach 706 disclosed herein. In a token merging approach 702, a unique token downsampling project is performed with a fixed number of tokens. These approaches are problematic and the benefit of the disclosed approach is in the unique token downsampling layer 706. As shown in FIG. 7, in the merging approach 702, a transformer 708 can output M learned tokens based on N input tokens. This approach can be performed by known software tools like PathChMerger, Perceiver, and TokenLearner. This is typically positioned in the middle of the network architecture. For example, it is usually in the middle of the architecture for PatChmerger and TokenLearner, and with a very small number of output tokens M (e.g. M=16). For Perceiver, it is often in the beginning of the architecture (and sometimes even repeated in the middle of the architecture), but in practice the number of learned tokens M is rather large (e.g. M=512), so the Perceiver is not very competitive in terms of efficiency compared to other efficient transformers.

The first half of the network would still be inefficient as it is processing N tokens until the token merging 702 occurs to reduce the number to M tokens. A transformer 708 outputs M tokens as learned projection directions and which is a smaller number than the N input tokens. Note that the transition or merging of tokens occurs about in the middle of the processing by the transformer 708 as represented by its shape.

A token pruning approach 704 is also shown in which a slow iterative token reduction is performed with a fixed token pruning ratio. For example, tokens can be ranked by (decreasing) class attention (attention with respect to a special class token) and then the transformer 710 can prune a certain percentage of the low ranked tokens on a periodic basis as is presented by the shape of the transformer 710. This approach typically will prune a fixed x percentage of the tokens at each operation of the transformer 710 and is thus not very flexible.

The present approach 706 includes a unique token downsampling layer with a dynamic number of tokens. The pre-processing engine 402 can select a dynamic scale of token for each spatial position with a lightweight preprocessing engine. Note the shape of the rectangle 712 associated with transformer 226. In that case, there are a small number of tokens throughout the entire process (the number of tokens does not change or get pruned or merged). The image 716 in that is can be more simple and not need as many tokens for processing. The shape of the rectangle 714 associated with the transformer 226 represents the concept that more tokens are needed for a more complex image 718. The number of tokens remains the same throughout the transformer processing which is also represented in the shape of rectangles 712, 714.

The transformer 226 can be a lightweight preproprocessing module. The transformer 226 can be a unified model in that it can handle different scales of tokens in the same input set as is shown. The process selects a dynamic scale of token for search spatial position. Benefits of this approach include early token reduction plus a task-agnostic gate can easily be transferred to only one routing decision for any transformer model. In some cases, the preprocessing engine 402 is configured to process the input image as a first layer or one of the first layers in the overall model. That way, no pruning or merging of tokens is needed at various stages of processing in the network and the number of tokens can remain the same through the network.

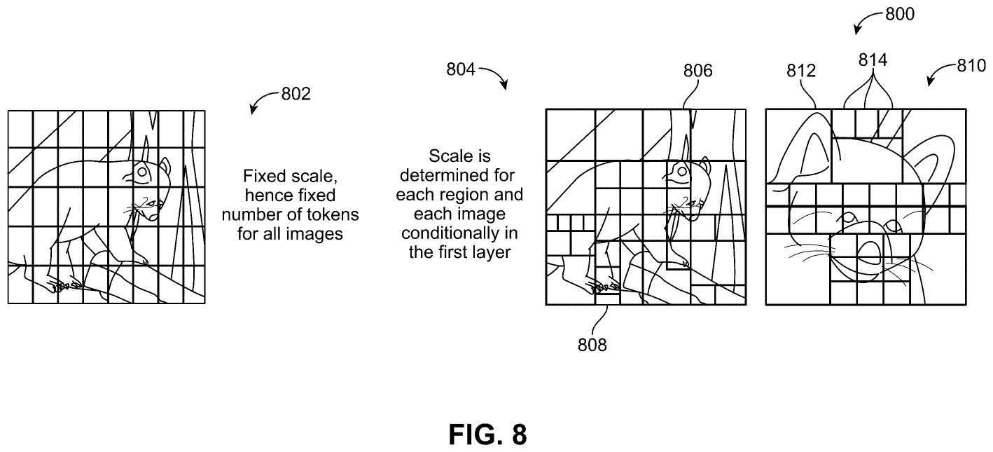

FIG. 8 is a diagram 800 illustrating the comparison of fixed scale tokens and a dynamic mixed-scale pattern, according to aspects of the disclosure. For example, in a fixed scale approach, 802, there is a fixed number of tokens for all images. In the example fixed scale approach 802, there are 64 tokens used to represent the image. In the present approach 804, the scale associated with tokens for each region is determined. In example 804, some tokens like token 806 is large because of the characteristics of the image in that region and other tokens like token 808 are relatively smaller. In image 810, the token 812 is large or coarse in nature and tokens 814 are relatively smaller and cover a fine resolution.

FIG. 9 is a diagram 900 illustrating a binary gate decision process for each spatial position and each input image, according to aspects of the disclosure. The clear regions 902 represent a coarse scale resolution for that region and the filled in regions 904 represent a fine scale for that region. The horizontal axis represents the spatial position of the region and the vertical axis represents the input image, where each row relates to a separate respective input image. The token selection by the gate 408 occurs across these two dimensions. For each respective image and each respective region of that image there is a binary decision that is made. The distribution of binary decisions across the diagram 900 can inform how conditional the model is. The idea would be to ensure that there are different patterns across different images. If the patterns across the different images was the same, then the system would not introduce efficiencies in that the system could just prune some of the images to reduce the computations. In general, the enhanced conditional approach acts on both the input image dimension and the spatial position dimension such that each image has its own behavior response by the gate and each token has its own behavior response by the gate as well. Other training loss approaches are inferior to this novel approach. For example, a mean constraint training loss (L₀ loss) which sets a value such as desiring half the tokens to be at the coarse scale and the other half of the tokens at the fine scale can lead to target sparsity with no conditionality. This approach constrains only the mean of the distribution. A batch shaping loss across input image dimensions is also not desirable since every spatial position has the same sparsity pattern. There is conditionality per image but in a batch shaping loss approach, it is only across one dimension (per image) and not for every spatial position. Here, the system constrains the distribution along samples to follow a Beta prior with a mean μ.

In one example, the mean can be a parameter learned per the model, independently for each spatial position, thus encouraging conditionality across spatial positions. In contrast, a batch shaping loss would assume the mean μ to be the same for all spatial positions

Conditionality means that if two different images are input to the model, the model should output two different behaviors or masks which are conditioned on the characteristics of the respective image. Such enhanced conditionality is achieved in the approach in which the binary gate decision (the training of the gate) is for each spatial position as well as for each input image. In one aspect, the disclosed approach can be characterized as hyperprior training in which the system constrains each token-specific distribution to follow a different learned prior. The learned parameters are controlled by the hyperprior (e.g., but not restricted to a Gaussian N, whose flexibility depends on an additional variance hyperparameter σ). Given a data training batch with N samples and d input tokens, the aggregated outputs of all the gate can be denoted as G, a matrix of size (N, d). The gate 408 can be trained as to match a certain target sparsity μ.

In one example, the spatial position 908 highlighted across the images is always chosen to be at the coarse scale. In this case, the entropy is low for this spatial position and the model is wasting training capacity which may lead to lower accuracies. The system may determine that it does not need to learn a gate for that spatial position as the token is always off for that spatial position. The gate 408 should be trained for each image and the use of the information in FIG. 9 can aid in how to train the model and provide for enhanced conditionality to improve efficiency by perhaps avoiding training a gate for a spatial position having low entropy across the images.

With a learned condition gate 408, the model matches static mixed resolution accuracy, but has the benefit of allowing for dynamic computational cost per image. The approach can enable a decrease in the computational cost without the loss of accuracy.

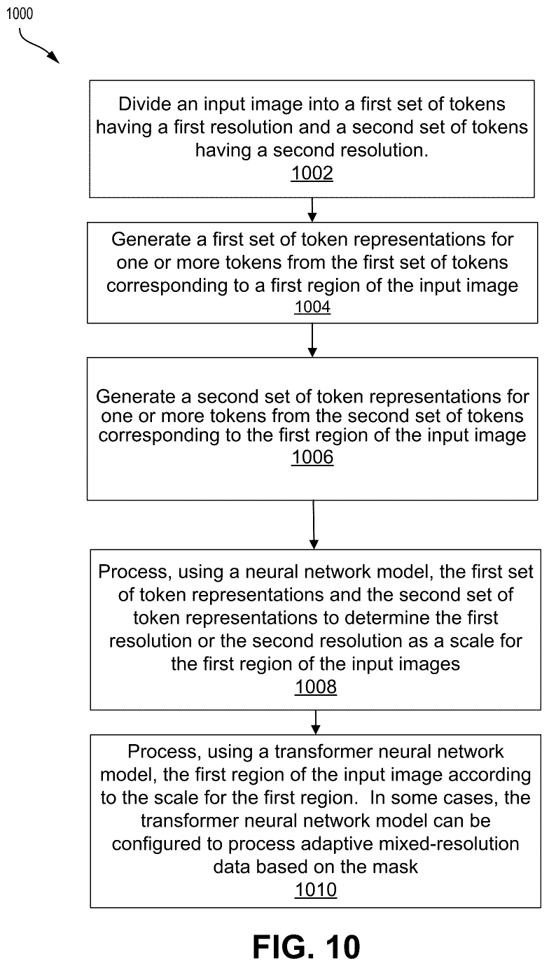

FIG. 10 illustrates an example method 1000 of processing image data, such as using a pre-processing engine 402 (e.g., as described with respect to FIG. 4). At block 1002, the method 1000 can include dividing an input image into a first set of tokens having a first resolution and a second set of tokens having a second resolution. In some cases, the first set of token representations includes a single token representation according to the first resolution, and the second set of token representations includes a plurality of token representations according to the second resolution. In some cases, the first resolution or the second resolution can be determined as the scale for the first region of the input image based on one or more characteristics of the input image. In some cases, the one or more characteristics of the input image can include a smoothness value associated with the first region of the input image, a complexity value associated with the first region of the input image, how many colors are associated with the input image, or a contrast value associated with the first region of the input image. In some cases, the input image includes an image patch of an image.

At block 1004, the method 1000 can include generating a first set of token representations for one or more tokens from the first set of tokens corresponding to a first region of the input image. In some cases, generating the first set of token representations can include processing the first set of tokens using a linear neural network layer to generate a first set of embedding vectors.

At block 1006, the method 1000 can include generating a second set of token representations for one or more tokens from the second set of tokens corresponding to the first region of the input image. In some cases, generating the second set of token representations can include processing the second set of tokens using the linear neural network layer to generate a second set of embedding vectors.

At block 1008, the method 1000 can include processing, using a neural network model, the first set of token representations and the second set of token representations to determine the first resolution or the second resolution as a scale for the first region of the input image. In some cases, the neural network model is shared across regions of the input image. In some cases, the neural network model can include a Softmax layer configured to determine a distribution over the first resolution and the second resolution.

At block 1010, the method 1000 can include processing, using a transformer neural network model, the first region of the input image according to the scale for the first region. In some cases, the transformer neural network model can be configured to process adaptive mixed-resolution data based on the mask.

In some cases, the method 1000 can further concatenating the first set of token representations and the second set of token representations to generate a set of concatenated token representations. The processing of the first set of token representations and the second set of token representations can include processing, using the neural network model, the set of concatenated token representations to determine the first resolution or the second resolution as the scale for the first region of the input image.

In some cases, the method 1000 can further include determining a respective scale for each respective region of the input image and/or determining a respective positional encoding for each region of the input image.

In some cases, for a region of the input image determined to have a scale corresponding to the second resolution, the method 1000 can include determining the respective positional encoding comprises determining a final positional encoding for the region as a linear interpolation of a plurality of initial positional encodings determined for the region.

In some cases, the method 1000 can further include generating a mask for the input image, the mask indicating a respective scale determined for each respective region of the input image as the first resolution or the second resolution.

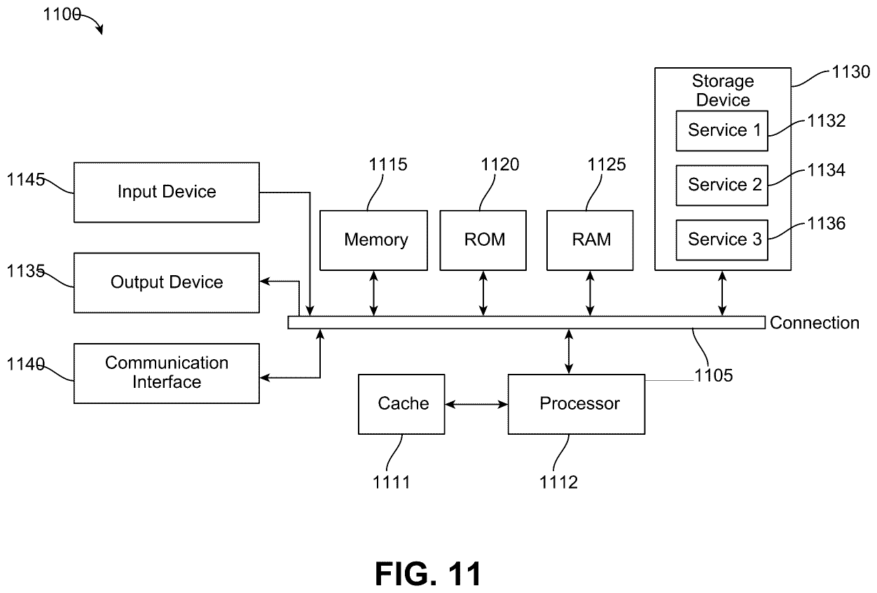

In some examples, the processes described herein (e.g., method 1000 and/or other process described herein) may be performed by a computing device or apparatus. In one example, the method 1000 can be performed by the computing system 1100 shown in FIG. 11.

The computing device can include any suitable device, such as a mobile device (e.g., a mobile phone), a desktop computing device, a tablet computing device, a wearable device (e.g., a VR headset, an AR headset, AR glasses, a network-connected watch or smartwatch, or other wearable device), a server computer, an autonomous vehicle or computing device of an autonomous vehicle, a robotic device, a television, and/or any other computing device with the resource capabilities to perform the processes described herein, including the method 500 and/or other process described herein. In some cases, the computing device or apparatus may include various components, such as one or more input devices, one or more output devices, one or more processors, one or more microprocessors, one or more microcomputers, one or more cameras, one or more sensors, and/or other component(s) that are configured to carry out the steps of processes described herein. In some examples, the computing device may include a display, a network interface configured to communicate and/or receive the data, any combination thereof, and/or other component(s). The network interface may be configured to communicate and/or receive Internet Protocol (IP) based data or other type of data.

The components of the computing device can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein.

The method 1000 is illustrated as logical flow diagrams, the operation of which represents a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, the method 1000 and/or other process described herein may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program comprising a plurality of instructions executable by one or more processors. The computer-readable or machine-readable storage medium may be non-transitory.

The approach disclosed herein includes a combination of features not found in other approaches. The disclosed features can include one or more of a mixed scale for a set of tokens, can include a dynamic feature in which the number of tokens in a masked set of tokens can vary from image to image. The approach is lossless in that each portion of an image is represented by one or more tokens at a given scale. Thus, no portion of the image is not represented and thus there is no loss. The approach also provides an efficient feed-forward network (FFN) in the transformer. There are a reduced number of MACs operation counts in the FFN. No other approach has all of these properties. The application of this approach can include image classification but is not limited to that context. Any vision task can benefit from these concepts and particularly dense tasks such as segmentation. Any vision transformer can utilize this pre-processing engine 402 disclosed herein. Other uses can include real-time video processing, extended reality, or any other visual processing.

FIG. 11 is a diagram illustrating an example of a system for implementing certain aspects of the present technology. In particular, FIG. 11 illustrates an example of computing system 1100, which can be for example any computing device making up internal computing system, a remote computing system, a camera, or any component thereof in which the components of the system are in communication with each other using connection 1105. Connection 1105 can be a physical connection using a bus, or a direct connection into processor 1110, such as in a chipset architecture. Connection 1105 can also be a virtual connection, networked connection, or logical connection.

In some aspects, computing system 1100 is a distributed system in which the functions described in this disclosure can be distributed within a datacenter, multiple data centers, a peer network, etc. In some aspects, one or more of the described system components represents many such components each performing some or all of the function for which the component is described. In some aspects, the components can be physical or virtual devices.

Example system 1100 includes at least one processing unit (CPU or processor) 1110 and connection 1105 that couples various system components including system memory 1115, such as read-only memory (ROM) 1120 and random-access memory (RAM) 1125 to processor 1110. Computing system 1100 can include a cache 1111 of high-speed memory connected directly with, in close proximity to, or integrated as part of processor 1110.

Processor 1110 can include any general-purpose processor and a hardware service or software service, such as services 1132, 1134, and 1136 stored in storage device 1130, configured to control processor 1110 as well as a special-purpose processor where software instructions are incorporated into the actual processor design. Processor 1110 may essentially be a completely self-contained computing system, containing multiple cores or processors, a bus, memory controller, cache, etc. A multi-core processor may be symmetric or asymmetric.

To enable user interaction, computing system 1100 includes an input device 1145, which can represent any number of input mechanisms, such as a microphone for speech, a touch-sensitive screen for gesture or graphical input, keyboard, mouse, motion input, speech, etc. Computing system 1100 can also include output device 1135, which can be one or more of a number of output mechanisms. In some instances, multimodal systems can enable a user to provide multiple types of input/output to communicate with computing system 1100. Computing system 1100 can include communications interface 1140, which can generally govern and manage the user input and system output.

The communication interface may perform or facilitate receipt and/or transmission wired or wireless communications using wired and/or wireless transceivers, including those making use of an audio jack/plug, a microphone jack/plug, a universal serial bus (USB) port/plug, an Apple® Lightning® port/plug, an Ethernet port/plug, a fiber optic port/plug, a proprietary wired port/plug, a BLUETOOTH® wireless signal transfer, a BLUETOOTH® low energy (BLE) wireless signal transfer, an IBEACON® wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, WLAN signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/5G/long term evolution (LTE) cellular data network wireless signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof.

The communications interface 1140 may also include one or more GNSS receivers or transceivers that are used to determine a location of the computing system 1100 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 1130 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a Europay, Mastercard and Visa (EMV) chip, a subscriber identity module (SIM) card, a mini/micro/nano/pico SIM card, another integrated circuit (IC) chip/card, RAM, static RAM (SRAM), dynamic RAM (DRAM), ROM, programmable read-only memory (PROM), erasable programmable read-only memory (EPROM), electrically erasable programmable read-only memory (EEPROM), flash EPROM (FLASHEPROM), cache memory (L1/L2/L3/L4/L5/L#), resistive random-access memory (RRAM/ReRAM), phase change memory (PCM), spin transfer torque RAM (STT-RAM), another memory chip or cartridge, and/or a combination thereof.

The storage device 1130 can include software services, servers, services, etc., that when the code that defines such software is executed by the processor 1110, it causes the system to perform a function. In some aspects, a hardware service that performs a particular function can include the software component stored in a computer-readable medium in connection with the necessary hardware components, such as processor 1110, connection 1105, output device 1135, etc., to carry out the function. The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections.

The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, an engine, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

In some aspects, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Specific details are provided in the description above to provide a thorough understanding of the aspects and examples provided herein. However, it will be understood by one of ordinary skill in the art that the aspects may be practiced without these specific details. For clarity of explanation, in some instances the present technology may be presented as including individual functional blocks including devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general-purpose computer, special purpose computer, or a processing device to perform a certain function or group of functions. Portions of computer resources used can be accessible over a network. The computer executable instructions may be, for example, binaries, intermediate format instructions such as assembly language, firmware, source code. Examples of computer-readable media that may be used to store instructions, information used, and/or information created during methods according to described examples include magnetic or optical disks, flash memory, USB devices provided with non-volatile memory, networked storage devices, and so on.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific aspects thereof, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

One of ordinary skill will appreciate that the less than (“<”) and greater than (“>”) symbols or terminology used herein can be replaced with less than or equal to (“<”) and greater than or equal to (“ ”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language in the disclosure reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

The various illustrative logical blocks, modules, engines, circuits, and algorithm steps described in connection with the examples disclosed herein may be implemented as electronic hardware, computer software, firmware, or combinations thereof. To clearly illustrate this interchangeability of hardware and software, various illustrative components, blocks, modules, engines, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules, engines, or components may be implemented together in an integrated logic device or separately as discrete but interoperable logic devices. If implemented in software, then the techniques may be realized at least in part by a computer-readable data storage medium including program code including instructions that, when executed, performs one or more of the methods, algorithms, and/or operations described above. The computer-readable data storage medium may form part of a computer program product, which may include packaging materials. The computer-readable medium may include memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

Illustrative aspects of the disclosure include:

Aspect 1. A processor-implemented method of processing image data, the method comprising: dividing an input image into a first set of tokens having a first resolution and a second set of tokens having a second resolution; generating a first set of token representations for one or more tokens from the first set of tokens corresponding to a first region of the input image; generating a second set of token representations for one or more tokens from the second set of tokens corresponding to the first region of the input image; processing, using a neural network model, the first set of token representations and the second set of token representations to determine the first resolution or the second resolution as a scale for the first region of the input image; and processing, using a transformer neural network model, the first region of the input image according to the scale for the first region.

Aspect 2. The processor-implemented method of Aspect 1, wherein: generating the first set of token representations comprises processing the first set of tokens using a linear neural network layer to generate a first set of embedding vectors; and generating the second set of token representations comprises processing the second set of tokens using the linear neural network layer to generate a second set of embedding vectors.

Aspect 3. The processor-implemented method of any of Aspects 1 or 2, wherein the first set of token representations includes a single token representation according to the first resolution, and wherein the second set of token representations includes a plurality of token representations according to the second resolution.

Aspect 4. The processor-implemented method of any of Aspects 1 to 3, further comprising: concatenating the first set of token representations and the second set of token representations to generate a set of concatenated token representations; wherein processing the first set of token representations and the second set of token representations comprises processing, using the neural network model, the set of concatenated token representations to determine the first resolution or the second resolution as the scale for the first region of the input image.

Aspect 5. The processor-implemented method of any of Aspects 1 to 4, further comprising: determining a respective scale for each respective region of the input image.

Aspect 6. The processor-implemented method of any of Aspects 1 to 5, further comprising: determining a respective positional encoding for each region of the input image.

Aspect 7. The processor-implemented method of any of Aspects 1 to 6, wherein, for a region of the input image determined to have a scale corresponding to the second resolution, determining the respective positional encoding comprises determining a final positional encoding for the region as a linear interpolation of a plurality of initial positional encodings determined for the region.

Aspect 8. The processor-implemented method of any of Aspects 1 to 7, further comprising: generating a mask for the input image, the mask indicating a respective scale determined for each respective region of the input image as the first resolution or the second resolution.

Aspect 9. The processor-implemented method of any of Aspects 1 to 8, wherein the transformer neural network model is configured to process adaptive mixed-resolution data based on the mask.

Aspect 10. The processor-implemented method of any of Aspects 1 to 9, wherein the neural network model is shared across regions of the input image.

Aspect 11. The processor-implemented method of any of Aspects 1 to 10, wherein the neural network model includes a Softmax layer configured to determine a distribution over the first resolution and the second resolution.

Aspect 12. The processor-implemented method of any of Aspects 1 to 11, wherein the first resolution or the second resolution is determined as the scale for the first region of the input image based on one or more characteristics of the input image.

Aspect 13. The processor-implemented method of any of Aspects 1 to 12, wherein the one or more characteristics of the input image include a smoothness value associated with the first region of the input image, a complexity value associated with the first region of the input image, how many colors are associated with the input image, or a contrast value associated with the first region of the input image.

Aspect 14. The processor-implemented method of any of Aspects 1 to 13, wherein the input image includes an image patch of an image.

Aspect 15. An apparatus for processing image data, comprising: at least one memory; and at least one processor coupled to at least one memory and configured to: divide an input image into a first set of tokens having a first resolution and a second set of tokens having a second resolution; generate a first set of token representations for one or more tokens from the first set of tokens corresponding to a first region of the input image; generate a second set of token representations for one or more tokens from the second set of tokens corresponding to the first region of the input image; process, using a neural network model, the first set of token representations and the second set of token representations to determine the first resolution or the second resolution as a scale for the first region of the input image; and process, using a transformer neural network model, the first region of the input image according to the scale for the first region.

Aspect 16. The apparatus for processing image data of Aspect 15, wherein the at least one processor is further configured to: generate the first set of token representations comprises processing the first set of tokens using a linear neural network layer to generate a first set of embedding vectors; and generate the second set of token representations comprises processing the second set of tokens using the linear neural network layer to generate a second set of embedding vectors.

Aspect 17. The apparatus for processing image data of Aspects 15 or 16, wherein the first set of token representations includes a single token representation according to the first resolution, and wherein the second set of token representations includes a plurality of token representations according to the second resolution.

Aspect 18. The apparatus for processing image data of Aspects 15 to 17, wherein the at least one processor is further configured to: concatenate the first set of token representations and the second set of token representations to generate a set of concatenated token representations; process, using the neural network model, the set of concatenated token representations to determine the first resolution or the second resolution as the scale for the first region of the input image.

Aspect 19. The apparatus for processing image data of Aspects 15 to 18, wherein the at least one processor is further configured to: determine a respective scale for each respective region of the input image.

Aspect 20. The apparatus for processing image data of Aspects 15 to 19, wherein the at least one processor is further configured to: determine a respective positional encoding for each region of the input image.

Aspect 21. The apparatus for processing image data of Aspects 15 to 20, wherein the at least one processor is further configured to: for a region of the input image determined to have a scale corresponding to the second resolution, determine the respective positional encoding by determining a final positional encoding for the region as a linear interpolation of a plurality of initial positional encodings determined for the region.

Aspect 22. The apparatus for processing image data of Aspects 15 to 21, wherein the at least one processor is further configured to: generate a mask for the input image, the mask indicating a respective scale determined for each respective region of the input image as the first resolution or the second resolution.

Aspect 23. The apparatus for processing image data of Aspects 15 to 22, wherein the transformer neural network model is configured to process adaptive mixed-resolution data based on the mask.

Aspect 24. The apparatus for processing image data of Aspects 15 to 23, wherein the neural network model is shared across regions of the input image.

Aspect 25. The apparatus for processing image data of Aspects 15 to 24, wherein the neural network model includes a Softmax layer configured to determine a distribution over the first resolution and the second resolution.

Aspect 26. The apparatus for processing image data of Aspects 15 to 25, wherein the first resolution or the second resolution is determined as the scale for the first region of the input image based on one or more characteristics of the input image.

Aspect 27. The apparatus for processing image data of Aspects 15 to 26, wherein the one or more characteristics of the input image include a smoothness value associated with the first region of the input image, a complexity value associated with the first region of the input image, how many colors are associated with the input image, or a contrast value associated with the first region of the input image.

Aspect 28. The apparatus for processing image data of Aspects 15 to 27, wherein the input image includes an image patch of an image.

Aspect 29. A non-transitory computer-readable medium having stored thereon instructions that, when executed by one or more processors, cause the one or more processors to perform operations according to any of Aspects 1 to 14.

Aspect 30. An apparatus for classifying image data on a mobile device, the apparatus including one or more means for performing operations according to any of Aspects 1 to 14.

What is claimed is:

1. A processor-implemented method of processing image data, the method comprising:
dividing an input image into a first set of tokens having a first resolution and a second set of tokens having a second resolution;
generating a first set of token representations for one or more tokens from the first set of tokens corresponding to a first region of the input image;
generating a second set of token representations for one or more tokens from the second set of tokens corresponding to the first region of the input image;
processing, using a neural network model, the first set of token representations and the second set of token representations to determine the first resolution or the second resolution as a scale for the first region of the input image; and
processing, using a transformer neural network model, the first region of the input image according to the scale for the first region.

2. The processor-implemented method of claim 1, wherein:
generating the first set of token representations comprises processing the first set of tokens using a linear neural network layer to generate a first set of embedding vectors; and
generating the second set of token representations comprises processing the second set of tokens using the linear neural network layer to generate a second set of embedding vectors.

3. The processor-implemented method of claim 1, wherein the first set of token representations includes a single token representation according to the first resolution, and wherein the second set of token representations includes a plurality of token representations according to the second resolution.

4. The processor-implemented method of claim 1, further comprising:
concatenating the first set of token representations and the second set of token representations to generate a set of concatenated token representations;
wherein processing the first set of token representations and the second set of token representations comprises processing, using the neural network model, the set of concatenated token representations to determine the first resolution or the second resolution as the scale for the first region of the input image.

5. The processor-implemented method of claim 1, further comprising:
determining a respective scale for each respective region of the input image.

6. The processor-implemented method of claim 5, further comprising:
determining a respective positional encoding for each region of the input image.

7. The processor-implemented method of claim 6, wherein, for a region of the input image determined to have a scale corresponding to the second resolution, determining the respective positional encoding comprises determining a final positional encoding for the region as a linear interpolation of a plurality of initial positional encodings determined for the region.

8. The processor-implemented method of claim 1, further comprising:
generating a mask for the input image, the mask indicating a respective scale determined for each respective region of the input image as the first resolution or the second resolution.

9. The processor-implemented method of claim 8, wherein the transformer neural network model is configured to process adaptive mixed-resolution data based on the mask.

10. The processor-implemented method of claim 1, wherein the neural network model is shared across regions of the input image.

11. The processor-implemented method of claim 1, wherein the neural network model includes a Softmax layer configured to determine a distribution over the first resolution and the second resolution.

12. The processor-implemented method of claim 1, wherein the first resolution or the second resolution is determined as the scale for the first region of the input image based on one or more characteristics of the input image.

13. The processor-implemented method of claim 12, wherein the one or more characteristics of the input image include a smoothness value associated with the first region of the input image, a complexity value associated with the first region of the input image, how many colors are associated with the input image, or a contrast value associated with the first region of the input image.

14. The processor-implemented method of claim 1, wherein the input image includes an image patch of an image.

15. An apparatus for processing image data, comprising:
at least one memory; and
at least one processor coupled to at least one memory and configured to:
divide an input image into a first set of tokens having a first resolution and a second set of tokens having a second resolution;
generate a first set of token representations for one or more tokens from the first set of tokens corresponding to a first region of the input image;
generate a second set of token representations for one or more tokens from the second set of tokens corresponding to the first region of the input image;
process, using a neural network model, the first set of token representations and the second set of token representations to determine the first resolution or the second resolution as a scale for the first region of the input image; and
process, using a transformer neural network model, the first region of the input image according to the scale for the first region.

16. The apparatus for processing image data of claim 15, wherein the at least one processor is further configured to:
generate the first set of token representations comprises processing the first set of tokens using a linear neural network layer to generate a first set of embedding vectors; and
generate the second set of token representations comprises processing the second set of tokens using the linear neural network layer to generate a second set of embedding vectors.

17. The apparatus for processing image data of claim 15, wherein the first set of token representations includes a single token representation according to the first resolution, and wherein the second set of token representations includes a plurality of token representations according to the second resolution.

18. The apparatus for processing image data of claim 15, wherein the at least one processor is further configured to:
concatenate the first set of token representations and the second set of token representations to generate a set of concatenated token representations; and
process, using the neural network model, the set of concatenated token representations to determine the first resolution or the second resolution as the scale for the first region of the input image.

19. The apparatus for processing image data of claim 15, wherein the at least one processor is further configured to:
determine a respective scale for each respective region of the input image.

20. The apparatus for processing image data of claim 19, wherein the at least one processor is further configured to:
determine a respective positional encoding for each region of the input image.

21. The apparatus for processing image data of claim 20, wherein the at least one processor is further configured to:
for a region of the input image determined to have a scale corresponding to the second resolution, determine the respective positional encoding by determining a final positional encoding for the region as a linear interpolation of a plurality of initial positional encodings determined for the region.

22. The apparatus for processing image data of claim 15, wherein the at least one processor is further configured to:
generate a mask for the input image, the mask indicating a respective scale determined for each respective region of the input image as the first resolution or the second resolution.

23. The apparatus for processing image data of claim 22, wherein the transformer neural network model is configured to process adaptive mixed-resolution data based on the mask.

24. The apparatus for processing image data of claim 15, wherein the neural network model is shared across regions of the input image.

25. The apparatus for processing image data of claim 15, wherein the neural network model includes a Softmax layer configured to determine a distribution over the first resolution and the second resolution.

26. The apparatus for processing image data of claim 15, wherein the at least one processor is configured to determine the first resolution or the second resolution as the scale for the first region of the input image based on one or more characteristics of the input image.

27. The apparatus for processing image data of claim 26, wherein the one or more characteristics of the input image include a smoothness value associated with the first region of the input image, a complexity value associated with the first region of the input image, how many colors are associated with the input image, or a contrast value associated with the first region of the input image.

28. The apparatus for processing image data of claim 15, wherein the input image includes an image patch of an image.
